(19) United States
(12) Patent Application Publication
(10) Pub. No.: US 2025/0246664 A1
(43) Pub. Date: Jul. 31, 2025

(54) MANIFOLD FOR FUEL CELL STACKS

(71) Applicant: Caterpillar Inc., Peoria, IL (US)

(72) Inventors: Chethan Koralagundi Basavaraj, Bangalore (IN); Balaji Kalyanarangan, Chennai (IN); Prakash Prashanth Ravi, Bengaluru (IN); David A. Pierpont, Dunlap, IL (US)

(73) Assignee: Caterpillar Inc., Peoria, IL (US)

(21) Appl. No.: 18/427,928

(22) Filed: Jan. 31, 2024

(51) Int. Cl. H01M 8/2484; H01M 8/249

(52) U.S. Cl. CPC H01M 8/2484; H01M 8/249

(57) ABSTRACT

A manifold for routing an operational fluid towards a first group of first fuel cell stacks and a second group of second fuel cell stacks. The manifold includes a body defining an inlet passageway and an outlet passageway. The inlet passageway defines an inlet for the operational fluid, an inlet header channel extending from the inlet, a plurality of inlet conduits fluidly branching out from the inlet header channel. Each inlet conduit defines a first fluid inflow port and a second fluid inflow port for routing the operational fluid. The outlet passageway defines an outlet for the used operational fluid, an outlet header channel extending from the outlet, a plurality of outlet conduits fluidly branching out from the outlet header channel. Each outlet conduit defines a first fluid outflow port and a second fluid outflow port for providing an exit passage to the used operational fluid.

### TECHNICAL FIELD

The present disclosure relates to a manifold for routing operational fluids into fuel cell stacks.

### BACKGROUND

A fuel cell is an electrochemical device that converts chemical energy of a fuel, such as, hydrogen, into electrical energy. Generally, at an anode of the fuel cell, hydrogen gas enters and splits into positively charged particles called protons. These protons travel through a polymer electrolyte membrane to a cathode of the fuel cell. At the cathode, a cathode gas, e.g., oxygen from the air may combine with the protons to form water, releasing electricity in the process.

In order to meet high power requirements, several fuel cells are connected or stacked to form a fuel cell stack to increase the output voltage. However, with an increase in the number of fuel cells, the requirement for the oxygen at the respective cathodes of the fuel cells also increases. For example, for a fuel cell stack with an output power in the range of 0.5 Megawatt, the requirement of the cathode gas at the cathode is approximately 2100 kilograms per hour of air. However, conventional manifolds that distribute oxygen to the cathodes within the fuel cell stack do not meet these requirements.

United Kingdom Publication No. 2,540,592 describes a fuel cell stack consisting of multiple fuel cells. Each fuel cell comprises a frame to define an electrolyte chamber for a liquid electrolyte. Each of the frames in the stack define apertures that are aligned in the fuel cell stack to define fluid flow headers with at least one fluid flow header for the liquid electrolyte. Each cell defines a linking passage between the electrolyte chamber and the fluid flow header for the liquid electrolyte. The cell stack also comprises a flow-modifying insert within the aperture providing the fluid flow header for the liquid electrolyte. The insert in combination with the header defines a flow channel whose cross-sectional area varies along the length of the insert.

### SUMMARY OF THE INVENTION

In one aspect, the disclosure relates to a manifold for routing an operational fluid towards a first group of first fuel cell stacks and a second group of second fuel cell stacks. The manifold includes a body for an intermediate placement between the first group and the second group. The body defines an inlet passageway for introducing the operational fluid into each of the first group and the second group. The inlet passageway defines an inlet for the operational fluid, an inlet header channel extending from the inlet, and a plurality of inlet conduits fluidly branching out from the inlet header channel. Each inlet conduit of the plurality of inlet conduits defines a first fluid inflow port and a second fluid inflow port for respectively routing the operational fluid, received through the inlet and the inlet header channel, into the first group and the second group. The body further defines an outlet passageway for releasing a used operational fluid out from each of the first group and the second group. The outlet passageway defines an outlet for the used operational fluid, an outlet header channel extending from the outlet, and a plurality of outlet conduits fluidly branching out from the outlet header channel. Each outlet conduit of the plurality of outlet conduits defines a first fluid outflow port and a second fluid outflow port for respectively providing an exit passage to the used operational fluid from the first group and the second group into the outlet header channel for an expulsion of the used operational fluid from the body through the outlet.

In another aspect, the disclosure is directed to a fuel cell package. The fuel cell package includes a housing, and a first group of first fuel cell stacks and a second group of second fuel cell stacks accommodated within the housing. Each of the first fuel cell stacks and the second fuel cell stacks define openings for a receipt and a passage of an operational fluid therethrough. The fuel cell package further includes a manifold for routing the operational fluid towards the first group and the second group. The manifold includes a body for an intermediate placement between the first group and the second group. The body defines an inlet passageway for introducing the operational fluid into each of the first group and the second group. The inlet passageway defines an inlet for the operational fluid, an inlet header channel extending from the inlet, and a plurality of inlet conduits fluidly branching out from the inlet header channel. Each inlet conduit of the plurality of inlet conduits defines a first fluid inflow port and a second fluid inflow port for respectively routing the operational fluid, received through the inlet and the inlet header channel, into the first group and the second group. The body further defines an outlet passageway for releasing a used operational fluid out from each of the first group and the second group. The outlet passageway defines an outlet for the used operational fluid, an outlet header channel extending from the outlet, and a plurality of outlet conduits fluidly branching out from the outlet header channel. Each outlet conduit of the plurality of outlet conduits defines a first fluid outflow port and a second fluid outflow port for respectively providing an exit passage to the used operational fluid from the first group and the second group into the outlet header channel for an expulsion of the used operational fluid from the body through the outlet.

In another aspect, the disclosure is directed to a method for operating a fuel cell package. The method includes using a manifold for routing a cathode gas towards a first group of first fuel cell stacks and a second group of second fuel cell stacks of the fuel cell package. The manifold includes a body. The method includes placing the body intermediately between the first group and the second group. The body defines an inlet passageway for introducing the cathode gas into each of the first group and the second group. The inlet passageway defines an inlet for the cathode gas, an inlet header channel extending from the inlet, and a plurality of inlet conduits fluidly branching out from the inlet header channel. Each inlet conduit of the plurality of inlet conduits defines a first fluid inflow port and a second fluid inflow port for respectively routing the cathode gas, received through the inlet and the inlet header channel, into the first group and the second group. The body further defines an outlet passageway for releasing a used cathode gas out from each of the first group and the second group. The outlet passageway defines an outlet for the used cathode gas, an outlet header channel extending from the outlet, and a plurality of outlet conduits fluidly branching out from the outlet header channel. Each outlet conduit of the plurality of outlet conduits defines a first fluid outflow port and a second fluid outflow port for respectively providing an exit passage to the used cathode gas from the first group and the second group into the outlet header channel for an expulsion of the used cathode gas from the body through the outlet.

### BRIEF DESCRIPTION OF THE DRAWINGS

FIG. 1 illustrates an exemplary fuel cell package, in accordance with one or more aspects of the present disclosure;

FIG. 2 illustrates a first group of first fuel cell stacks and a second group of second fuel cell stacks accommodated within a housing of the fuel cell package of FIG. 1, in accordance with one or more aspects of the present disclosure;

FIG. 3 illustrates a partial exploded view of a first fuel cell stack of the first group of FIG. 2, in accordance with one or more aspects of the present disclosure;

FIG. 4 illustrates a perspective view of a manifold placed between the first group and the second group of the fuel cell package of FIG. 1, in accordance with one or more aspects of the present disclosure;

FIG. 5 illustrates a cross-sectional view of the manifold taken along 5-5 shown in FIG. 4, in accordance with one or more aspects of the present disclosure;

FIG. 6 illustrates another cross-sectional view of the manifold taken along 6-6 shown in FIG. 4, in accordance with one or more aspects of the present disclosure; and

FIG. 7 is a flowchart illustrating a method for operating the fuel cell package, in accordance with one or more aspects of the present disclosure.

### DETAILED DESCRIPTION

Reference will now be made in detail to specific aspects or features, examples of which are illustrated in the accompanying drawings. Wherever possible, corresponding, or similar reference numbers will be used throughout the drawings to refer to the same or corresponding parts. Generally, corresponding reference numbers may be used throughout the drawings to refer to the same or corresponding parts, e.g., 1, 1′, and 1″ could refer to one or more comparable components used in the same and/or different depicted embodiments.

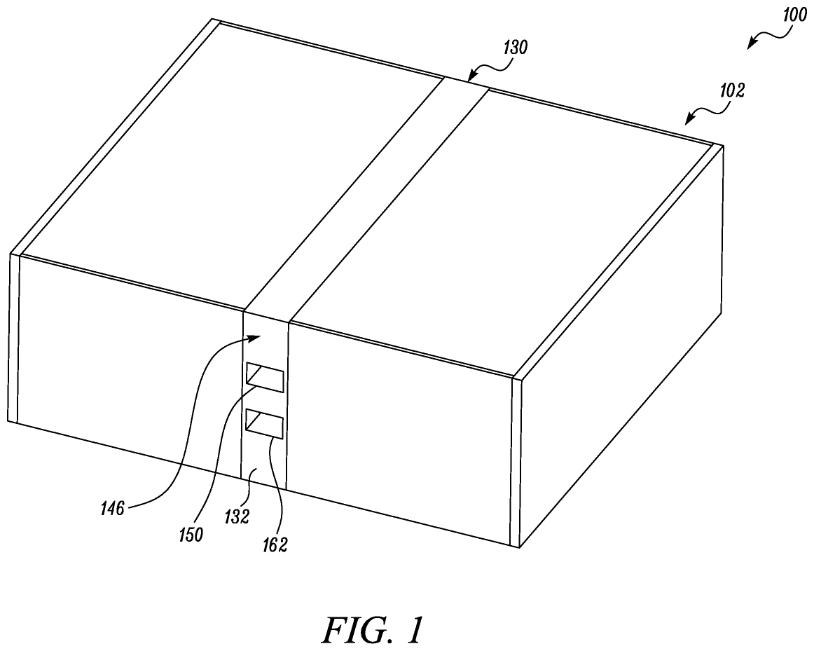

Referring to FIG. 1, an exemplary fuel cell package 100 is shown and described. The fuel cell package 100 may be employed in various applications such as work machines, electric vehicles, stationary power generation, aerospace applications, marine transportation, and the like. For example, the fuel cell package 100 may act as a power source that powers various electrical devices of a work machine (not shown), enabling the electrical devices to perform useful work. For example, the fuel cell package 100 may power one or more traction devices of the work machine to enable the work machine's travel or movement over and across a worksite. Additionally, the fuel cell package 100 may also power an actuation of an implement such that the implement can perform one or more work related functions of the work machine.

As shown in FIG. 1, the fuel cell package 100 includes a housing 102. The housing 102 may be made of any thermally insulating or thermally conductive materials, such as metal, ceramic, etc., depending upon the application of the fuel cell package 100. The housing 102 may have any suitable shape, for example, square, rectangular, or any other shape.

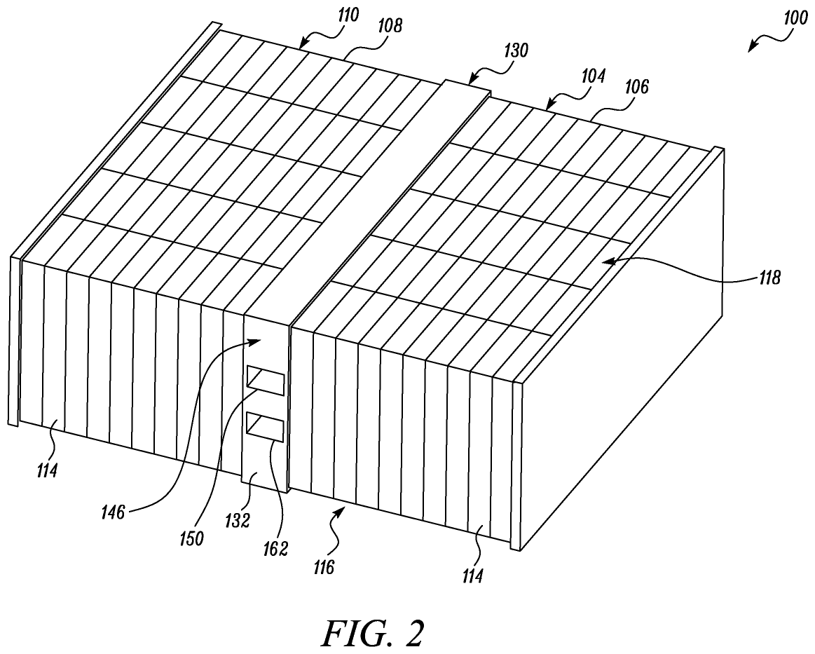

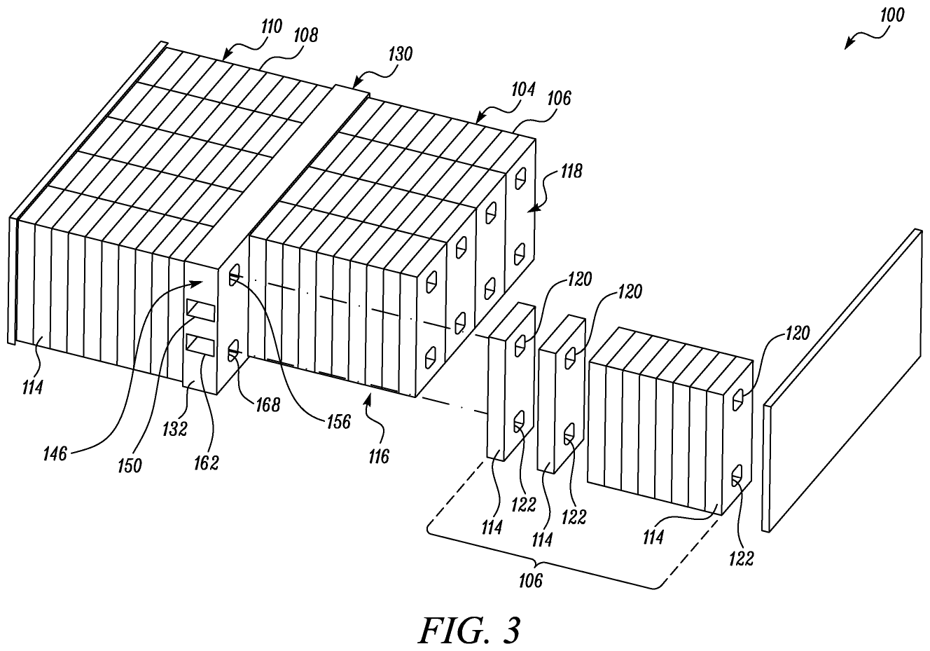

Referring to FIGS. 2 and 3, the housing 102 may accommodate a first group 104 of first fuel cell stacks 106 and a second group 110 of second fuel cell stacks 108. In accordance with various embodiments, each of the first group 104 and the second group 110 includes high-power fuel cell stacks. For example, a total output power of each of the first group 104 of the first fuel cell stacks 106 and the second group 110 of the second fuel cell stacks 108 may be greater than 200 KiloWatt (kW). Although FIG. 2 shows only five fuel cell stacks 106, 108 accommodated within the first group 104 and the second group 110, respectively, of the housing 102 of the fuel cell package 100, it would be appreciated that the first group 104 and the second group 110 may include any number of fuel cell stacks depending upon the application of the fuel cell package 100.

The first fuel cell stacks 106 and the second fuel cell stacks 108 may be arranged in the first group 104 and the second group 110, respectively, for example, in a plurality of columns 118. Each of the first fuel cell stacks 106 and the second fuel cell stacks 108 may include a series of fuel cells 114 arranged, for example, in a plurality of rows 116. Each fuel cell 114 may be composed of an anode (not shown), a cathode (not shown), and a membrane electrode assembly disposed between the anode and the cathode. An operational fluid, such as cathode gas, may be supplied to individual cathodes of each fuel cell 114 for the generation of power. In some embodiments, the operational fluid is anode gas, such as, hydrogen, that may be supplied to individual anodes of each fuel cell 114 for the generation of power. The fuel cells 114 may include Proton-Exchange Membrane (PEMFCs), Alkaline (AFCs), Phosphoric Acid (PAFCs), Solid Oxide (SOFCs), and the like. It would be appreciated that the fuel cells 114 are well-known in the art and further details/functioning of the same are not provided here for the sake of brevity.

Referring to FIG. 3, each of the first fuel cell stacks 106 and the second fuel cell stacks 108 define first openings 120 for a receipt and a passage of the operational fluid therethrough and second openings 122 for an exit and a passage of used operational fluid therethrough. The openings 120, 122 may be defined on each fuel cell 114 of the first fuel cell stacks 106 and the second fuel cell stacks 108. For example, the first openings 120 may be defined towards the upper end of the fuel cells 114 to receive the operational fluid. The operational fluid received by the individual openings 120 is further supplied to, for example, the individual cathodes or anodes of the fuel cells 114 for the generation of power. Similarly, the second openings 122 may be defined towards the bottom end of the fuel cells 114 for releasing the used operational fluid. In an embodiment, the operational fluid may include the cathode gas, such as, oxygen gas or any other gas or fluid required to be provided to individual cathodes of each fuel cell 114 for the functioning of the fuel cell 114. In some embodiments, the operational fluid may include the anode gas, such as, hydrogen gas or any other gas or fluid, required to be provided to individual anodes of each fuel cell 114 for the functioning of the fuel cell 114. The used operational fluid may correspond to the operational fluid that is depleted of some of its electrons during the process of the generation of power in the fuel cells 114.

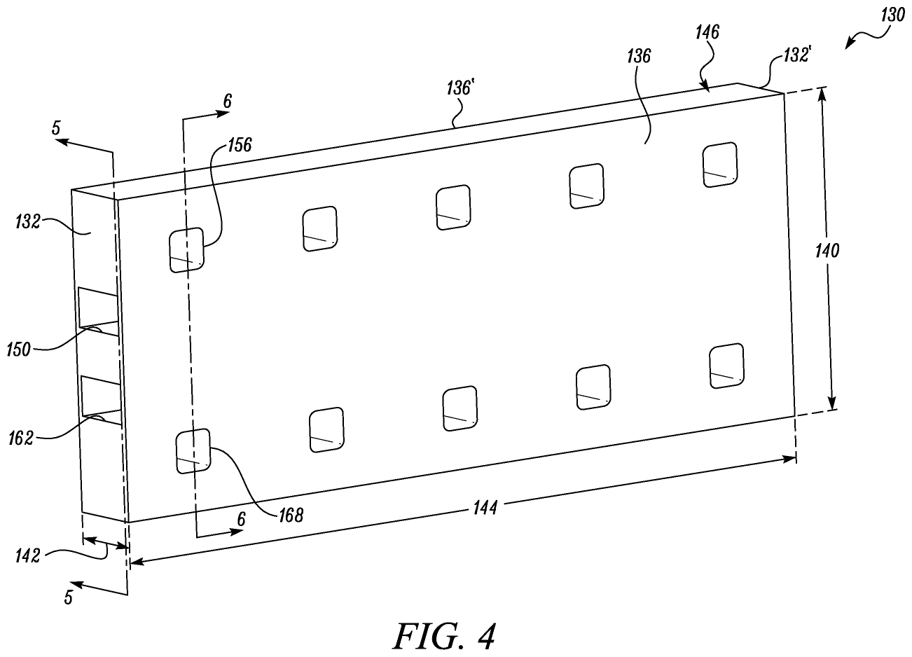

Referring to FIG. 4, the fuel cell package 100 includes a manifold 130 for routing the operational fluid towards the first group 104 and the second group 110. For example, the manifold 130 may be a cuboid-shaped structure having a pair of first sidewalls 132, 132′ and a pair of second sidewalls 136, 136′ extending between the pair of first sidewalls 132, 132. The pair of first sidewalls 132, 132 defines a height 140 and a width 142 of the manifold 130 while the pair of second sidewalls 136, 136′ defines a length 144 of the manifold 130. Although FIG. 4 shows the manifold 130 as a cuboid-shaped structure, it would be appreciated that the manifold 130 can have any suitable structure for routing the operational fluid, without departure from the claimed subject matter.

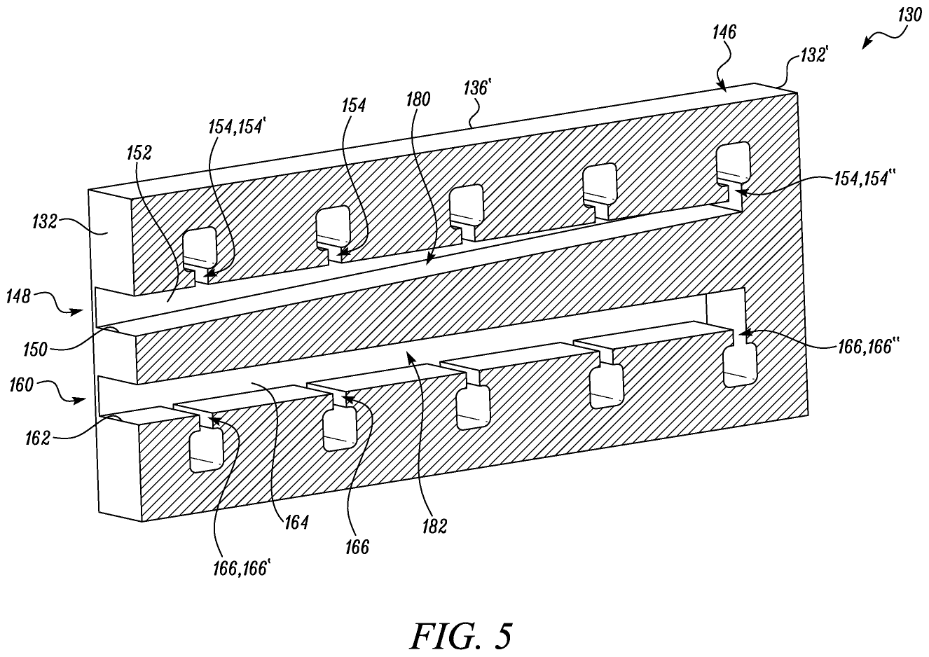

Referring to FIG. 5, the manifold 130 includes a body 146 for an intermediate placement between the first group 104 and the second group 110 (see placement of the manifold 130 shown in FIGS. 2 and 3). The body 146 of the manifold 130 can be made of any durable metal, such as, but not limited to, iron, steel, aluminum, and the like. The body 146 defines an inlet passageway 148 for introducing the operational fluid into each of the first group 104 and the second group 110. For example, the inlet passageway 148 introduces the operational fluid into the first openings 120 of the first fuel cell stacks 106 of the first group 104 and the second fuel cell stacks 108 of the second group 110.

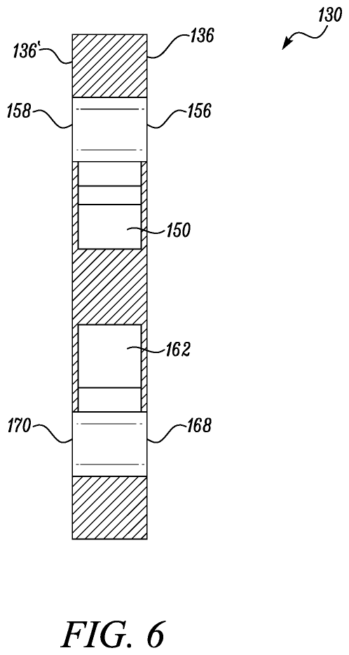

To this end, the inlet passageway 148 defines an inlet 150 for the operational fluid, an inlet header channel 152 extending from the inlet 150, and a plurality of inlet conduits 154 fluidly branching out from the inlet header channel 152. In accordance with various embodiments, the extension of the inlet header channel 152 from the inlet 150 into the body 146 includes a linear profile. As shown in FIG. 6, each inlet conduit 154 of the plurality of inlet conduits 154 defines a first fluid inflow port 156 and a second fluid inflow port 158 for respectively routing the operational fluid, received through the inlet 150 and the inlet header channel 152, into the first openings 120 of the first fuel cell stacks 106 of the first group 104 and the second fuel cell stacks 108 of the second group 110.

In accordance with various embodiments, the plurality of inlet conduits 154 are arranged in a first series with a first inlet conduit 154′ of the series being positioned closer to the inlet 150 than a last inlet conduit 154″ of the series. In accordance with various embodiments, a cross-sectional area 180 of the inlet header channel 152 progressively reduces from the first inlet conduit 154′ to the last inlet conduit 154″ to equalize a flow distribution of the operational fluid from the first inlet conduit 154′ to the last inlet conduit 154″.

The body 146 further includes an outlet passageway 160 for releasing the used operational fluid out from each of the first group 104 and the second group 110. For example, the outlet passageway 160 releases the used operational fluid from the second openings 122 of the first fuel cell stacks 106 of the first group 104 and the second fuel cell stacks 108 of the second group 110. The outlet passageway 160 defines an outlet 162 for the used operational fluid, an outlet header channel 164 extending from the outlet 162, and a plurality of outlet conduits 166 fluidly branching out from the outlet header channel 164. The extension of the outlet header channel 164 from the outlet 162 into the body 146 includes a linear profile. In accordance with various embodiments, the linear profile associated with the inlet header channel 152 is parallel to the linear profile associated with the outlet header channel 164. As shown in FIG. 6, each outlet conduit 166 of the plurality of outlet conduits 166 defines a first fluid outflow port 168 and a second fluid outflow port 170 for respectively providing an exit passage to the used operational fluid from the second openings 122 of the first fuel cell stacks 106 of the first group 104 and the second fuel cell stacks 108 of the second group 110 into the outlet header channel 164 for an expulsion of the used operational fluid from the body 146 through the outlet 162.

The plurality of outlet conduits 166 are arranged in a second series with a first outlet conduit 166′ of the second series being positioned closer to the outlet 162 than a last outlet conduit 166″ of the second series. A cross-sectional area 182 of the outlet header channel 164 may be same or constant from the first outlet conduit 166′ to the last outlet conduit 166″.

In accordance with various embodiments, the inlet 150 and the outlet 162 are located on the first sidewall 132 of the manifold 130 (shown in FIGS. 1 through 6). Further, the first fluid inflow port 156 and the first fluid outflow port 168 are located on the second sidewall 136 of the manifold 130 (shown in FIGS. 3, 4, and 6). The second fluid inflow port 158 and the second fluid outflow port 170 are located on the second sidewall 136′ of the manifold 130 (shown in FIG. 6).

### INDUSTRIAL APPLICABILITY

In any fuel cell package, operational fluid, such as the cathode gas to each fuel cell 114 and discharge the used operational fluid from each fuel cell 114 of the fuel cell package may be distributed. However, distribution and discharge of the operational fluid in a high-power fuel cell package, for example the fuel cell package 100, having a relatively large number of fuel cells 114 arranged in the form of stacks, for example, the first group 104 of the first fuel cell stacks 106 and the second group 110 of the second fuel cell stacks 108, becomes challenging due to increase in the volume of the operational fluid. FIGS. 1-6 describe the exemplary manifold 130 that can be employed to meet the requirement of distribution of large volumes of operational fluids in the high-power fuel cell. The exemplary manifold 130 evenly routes the large volume of the operational fluid towards the first group 104 of the first fuel cell stacks 106 and the second group 110 of the second fuel cell stacks 108 of the fuel cell package 100. Moreover, having a single inlet header channel 152 and a single outlet header channel 164 reduces overall bends or curves in the inlet passageway 148 and the outlet passageway 160, respectively, of the manifold 130, thereby utilizing the manifold size and shape more effectively and improving the power density of the manifold 130.

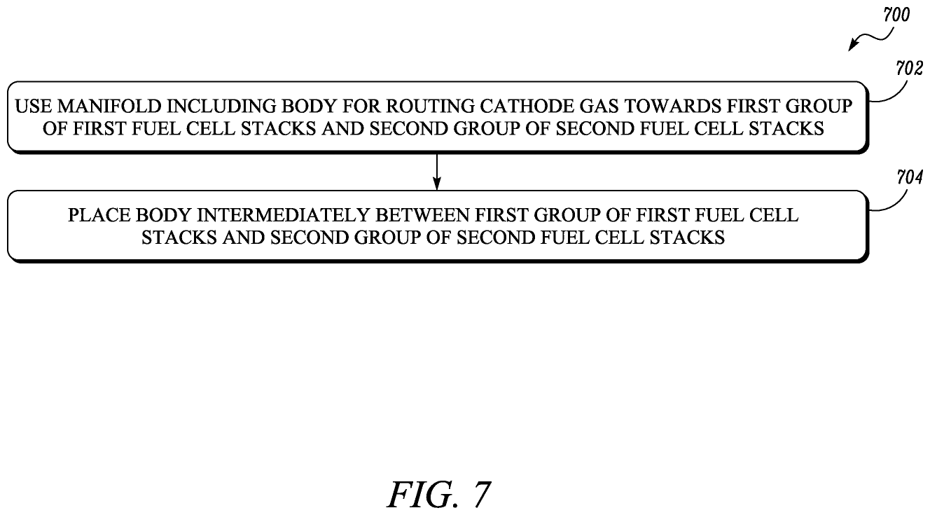

FIG. 7 is a flowchart illustrating a method 700 for operating the fuel cell package 100. The method 700 includes using the manifold 130 for routing the cathode gas towards the first group 104 of the first fuel cell stacks 106 and the second group 110 of the second fuel cell stacks 108 of the fuel cell package 100, at 702. At 704, the body 146 of the manifold 130 is placed intermediately between the first group 104 of the first fuel cell stacks 106 and the second group 110 of the second fuel cell stacks 108.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A manifold for routing an operational fluid towards a first group of first fuel cell stacks and a second group of second fuel cell stacks, the manifold comprising:
a body for an intermediate placement between the first group and the second group, the body defining:
an inlet passageway for introducing the operational fluid into each of the first group and the second group, the inlet passageway defining an inlet for the operational fluid, an inlet header channel extending from the inlet, and a plurality of inlet conduits fluidly branching out from the inlet header channel, each inlet conduit of the plurality of inlet conduits defining a first fluid inflow port and a second fluid inflow port for respectively routing the operational fluid, received through the inlet and the inlet header channel, into the first group and the second group; and
an outlet passageway for releasing a used operational fluid out from each of the first group and the second group, the outlet passageway defining an outlet for the used operational fluid, an outlet header channel extending from the outlet, and a plurality of outlet conduits fluidly branching out from the outlet header channel, each outlet conduit of the plurality of outlet conduits defining a first fluid outflow port and a second fluid outflow port for respectively providing an exit passage to the used operational fluid from the first group and the second group into the outlet header channel for an expulsion of the used operational fluid from the body through the outlet.

2. The manifold of claim 1, wherein the operational fluid is a cathode gas.

3. The manifold of claim 1, wherein the manifold includes a cuboid shaped structure having a pair of first sidewalls defining a height and a width of the manifold and a pair of second sidewalls extending between the pair of first sidewalls, the pair of second sidewalls defining a length of the manifold.

4. The manifold of claim 3, wherein the inlet and the outlet are located on one first sidewall of the pair of first sidewalls.

5. The manifold of claim 3, wherein
the first fluid inflow port and the first fluid outflow port are located on one second sidewall of the pair of second sidewalls, and
the second fluid inflow port and the second fluid outflow port are located on another second sidewall of the pair of second sidewalls.

6. The manifold of claim 1, wherein
an extension of the inlet header channel from the inlet into the body and an extension of the outlet header channel from the outlet into the body each include a linear profile, and
the linear profile associated with the inlet header channel is parallel to the linear profile associated with the outlet header channel.

7. The manifold of claim 1, wherein
the plurality of inlet conduits are arranged in a first series, with a first inlet conduit of the series being positioned closer to the inlet than a last inlet conduit of the series, and
a cross-sectional area of the inlet header channel progressively reduces from the first inlet conduit to the last inlet conduit to equalize a flow distribution of the operational fluid from the first inlet conduit to the last inlet conduit.

8. The manifold of claim 1, wherein
the plurality of outlet conduits are arranged in a second series, with a first outlet conduit of the second series being positioned closer to the outlet than a last outlet conduit of the second series, and
a cross-sectional area of the outlet header channel is same or constant from the first outlet conduit to the last outlet conduit.

9. The manifold of claim 1, wherein a total output power of each of the first group of the first fuel cell stacks and the second group of the second fuel cell stacks is greater than 200 KiloWatt (kW).

10. A fuel cell package, comprising:
a housing;
a first group of first fuel cell stacks and a second group of second fuel cell stacks accommodated within the housing, each of the first fuel cell stacks and the second fuel cell stacks defining openings for a receipt and a passage of an operational fluid therethrough;
a manifold for routing the operational fluid towards the first group and the second group, the manifold including:
a body for an intermediate placement between the first group and the second group, the body defining:
an inlet passageway for introducing the operational fluid into each of the first group and the second group, the inlet passageway defining an inlet for the operational fluid, an inlet header channel extending from the inlet, and a plurality of inlet conduits fluidly branching out from the inlet header channel, each inlet conduit of the plurality of inlet conduits defining a first fluid inflow port and a second fluid inflow port for respectively routing the operational fluid, received through the inlet and the inlet header channel, into the first group and the second group; and
an outlet passageway for releasing a used operational fluid out from each of the first group and the second group, the outlet passageway defining an outlet for the used operational fluid, an outlet header channel extending from the outlet, and a plurality of outlet conduits fluidly branching out from the outlet header channel, each outlet conduit of the plurality of outlet conduits defining a first fluid outflow port and a second fluid outflow port for respectively providing an exit passage to the used operational fluid from the first group and the second group into the outlet header channel for an expulsion of the used operational fluid from the body through the outlet.

11. The fuel cell package of claim 1, wherein the operational fluid is a cathode gas.

12. The fuel cell package of claim 1, wherein the manifold includes a cuboid shaped structure having a pair of first sidewalls defining a height and a width of the manifold and a pair of second sidewalls extending between the pair of first sidewalls, the pair of second sidewalls defining a length of the manifold.

13. The fuel cell package of claim 12, wherein the inlet and the outlet are located on one first sidewall of the pair of first sidewalls.

14. The fuel cell package of claim 12, wherein
the first fluid inflow port and the first fluid outflow port are located on one second sidewall of the pair of second sidewalls, and
the second fluid inflow port and the second fluid outflow port are located on another second sidewall of the pair of second sidewalls.

15. The fuel cell package of claim 1, wherein
an extension of the inlet header channel from the inlet into the body and an extension of the outlet header channel from the outlet into the body each include a linear profile, and
the linear profile associated with the inlet header channel is parallel to the linear profile associated with the outlet header channel.

16. The fuel cell package of claim 1, wherein
the plurality of inlet conduits are arranged in a first series, with a first inlet conduit of the series being positioned closer to the inlet than a last inlet conduit of the series, and
a cross-sectional area of the inlet header channel progressively reduces from the first inlet conduit to the last inlet conduit to equalize a flow distribution of the operational fluid from the first inlet conduit to the last inlet conduit.

17. The fuel cell package of claim 1, wherein
the plurality of outlet conduits are arranged in a second series, with a first outlet conduit of the second series being positioned closer to the outlet than a last outlet conduit of the second series, and
a cross-sectional area of the outlet header channel is same or constant from the first outlet conduit to the last outlet conduit.

18. The fuel cell package of claim 1, wherein a total output power of each of the first group of the first fuel cell stacks and the second group of the second fuel cell stacks is greater than 200 KiloWatt (kW).

19. A method for operating a fuel cell package, the method comprising:
using a manifold for routing a cathode gas towards a first group of fuel cell stacks and a second group of second fuel cell stacks of the fuel cell package, the manifold including a body; and
placing the body intermediately between the first group and the second group, the body defining:
an inlet passageway for introducing the cathode gas into each of the first group and the second group, the inlet passageway defining an inlet for the cathode gas, an inlet header channel extending from the inlet, and a plurality of inlet conduits fluidly branching out from the inlet header channel, each inlet conduit of the plurality of inlet conduits defining a first fluid inflow port and a second fluid inflow port for respectively routing the cathode gas, received through the inlet and the inlet header channel, into the first group and the second group,
an outlet passageway for releasing a used cathode gas out from each of the first group and the second group, the outlet passageway defining an outlet for the used cathode gas, an outlet header channel extending from the outlet, and a plurality of outlet conduits fluidly branching out from the outlet header channel, each outlet conduit of the plurality of outlet conduits defining a first fluid outflow port and a second fluid outflow port for respectively providing an exit passage to the used cathode gas from the first group and the second group into the outlet header channel for an expulsion of the used cathode gas from the body through the outlet.

20. The method of claim 19, wherein
the plurality of inlet conduits are arranged in a first series, with a first inlet conduit of the series being positioned closer to the inlet than a last inlet conduit of the series,
a cross-sectional area of the inlet header channel progressively reduces from the first inlet conduit to the last inlet conduit to equalize a flow distribution of the operational fluid from the first inlet conduit to the last inlet conduit,
the plurality of outlet conduits are arranged in a second series, with a first outlet conduit of the second series being positioned closer to the outlet than a last outlet conduit of the second series, and
a cross-sectional area of the outlet header channel is same or constant from the first outlet conduit to the last outlet conduit.
